(19) United States
(12) Patent Application Publication
(10) Pub. No.: US 2013/0044041 A1
(43) Pub. Date: Feb. 21, 2013

(54) PORTABLE ELECTRONIC DEVICE, ANTENNA STRUCTURE, AND ANTENNA PRODUCING PROCESS THEREOF

(71) Applicant: Chien-Hsin Liu, Hsinchu (TW)

(72) Inventor: Chien-Hsin Liu, Hsinchu (TW)

(73) Assignee: WISTRON NEWEB CORP, HSINCHU (TW)

(21) Appl. No.: 13/587,800

(22) Filed: Aug. 16, 2012

(30) Foreign Application Priority Data
Aug. 18, 2011 (TW) TW100129502
Aug. 14, 2012 (TW) TW101129309

(51) Int. Cl. H01Q 1/36; H01Q 13/00; H01Q 1/24

(52) U.S. Cl. 343/878; 343/700 MS; 29/600

(57) ABSTRACT

An antenna structure is provided, comprising: a first conductive layer, wherein the first conductive layer is formed by vacuum sputtering; and a second conductive layer formed over the first conductive layer, wherein the second conductive layer is formed by chemical plating, electroplating or printing.

### CROSS REFERENCE TO RELATED APPLICATIONS

This Application claims priority of Taiwan Patent Application No. 100129502, filed on Aug. 18, 2011, and priority of Taiwan Patent Application No. 101129309, filed on Aug. 14, 2012, the entirety of which is incorporated by reference herein.

### BACKGROUND OF THE INVENTION

1. Field of the Invention

The present invention relates to antenna fabrication, and in particular, to an antenna producing process for forming an antenna by a patterning process.

2. Description of the Related Art

Conventional antenna structures are typically composed of metal elements, which are fabricated by mechanical processes such as press molding. Conventional sheet metal antenna is formed with a larger volume, such that predetermined space is needed to be previously reserved in a case of an electronic device for the sheet metal antenna. Therefore, a size of the electronic device cannot be further reduced.

### BRIEF SUMMARY OF THE INVENTION

An exemplary antenna producing process is provided, comprising: providing a substrate having a substrate surface; forming a conductive layer on the substrate surface; and performing a patterning process to the conductive layer, forming an antenna pattern of the conductive layer.

An exemplary antenna structure is provided, comprising: a first conductive layer, wherein the first conductive layer is formed by vacuum sputtering; and a second conductive layer formed over the first conductive layer, wherein the second conductive layer is formed by chemical plating, electroplating or printing.

An exemplary portable electronic device is provided, comprising: a case; and an antenna structure formed over the case, wherein the antenna structure comprises a patterned composite conductive layer.

An exemplary antenna producing process is provided, comprising: providing a substrate having a substrate surface; forming a first conductive layer and a photoresist layer over the substrate surface; performing a patterning process to the photoresist layer, forming an opening in the photoresist layer, wherein the opening exposes a portion of the first conductive layer with an antenna pattern; performing a thickening process to the first conductive layer, forming a second conductive layer to increase a thickness of the antenna pattern on the portion of the first conductive layer exposed by the opening; and removing the photoresist layer, and etching portions of the first conductive layer without an increased thickness by using the second conductive layer formed on the portion of the first conductive layer as an etching mask.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a schematic diagram showing main steps of an antenna producing process according to an embodiment of the invention;

FIG. 1B is a schematic diagram showing detailed steps of the steps for performing the patterning process to the conductive layer in the antenna producing process in FIG. 1A;

FIG. 2A shows a substrate according to an embodiment of the invention;

FIG. 2B shows a conductive layer formed over a substrate surface of the substrate shown in FIG. 2A;

FIG. 2C shows a photomask having an antenna pattern;

FIG. 2D is a schematic diagram showing transfer of the antenna pattern to the photoresist layer by a plurality of photomasks aligned in various directions;

FIG. 3 shows an antenna structure according to an embodiment of the invention;

FIG. 4 is a cross sectional view of an antenna structure formed by an antenna producing process according to an embodiment of the invention;

FIG. 5A is a schematic diagram showing main steps of an antenna producing process according to another embodiment of the invention;

FIG. 5B is a schematic diagram showing detailed steps of the steps for performing the patterning process to the conductive layer in the antenna producing process in FIG. 5A;

FIG. 6 shows a composite conductive layer formed over a substrate surface of a substrate;

FIG. 7A is a schematic diagram showing main steps of an antenna producing process according to yet another embodiment of the invention;

FIG. 7B is a schematic diagram showing detailed steps of the steps for performing the patterning process to the conductive layer in the antenna producing process in FIG. 7A;

FIG. 8A shows a substrate according to another embodiment of the invention;

FIG. 8B shows a conductive layer and a photoresist layer formed over a substrate surface of a substrate;

FIG. 8C shows a photomask having an antenna pattern;

FIG. 8D is a schematic diagram showing transfer of the antenna pattern to the photoresist layer by a plurality of photomasks aligned in various directions;

FIG. 8E shows an opening of an antenna pattern formed in the photoresist layer;

FIG. 8F is schematic diagram after a thickening process is performed, wherein a second conductive layer is formed on the portion of the first conductive layer exposed by the opening to thereby increase a thickness of the portion of a first conductive layer exposed by the opening;

FIG. 9 shows an antenna structure according to yet another embodiment of the invention; and

FIG. 10 is a cross sectional view of an antenna structure formed by an antenna producing process according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

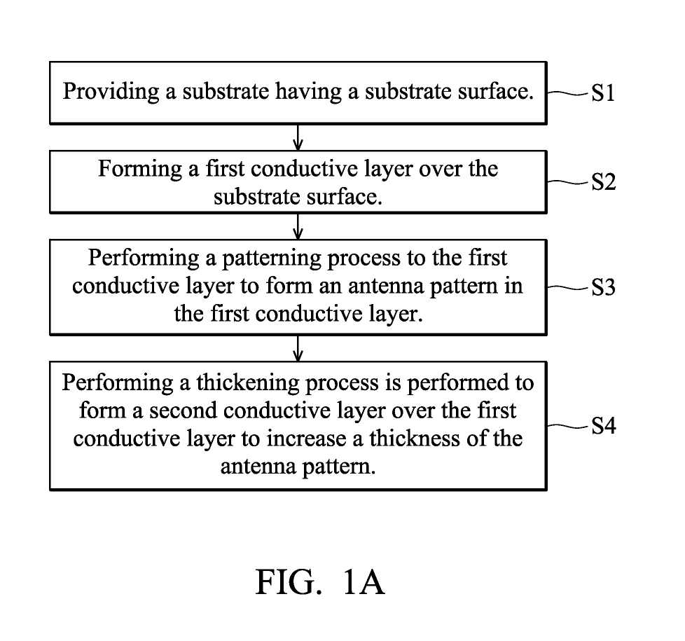

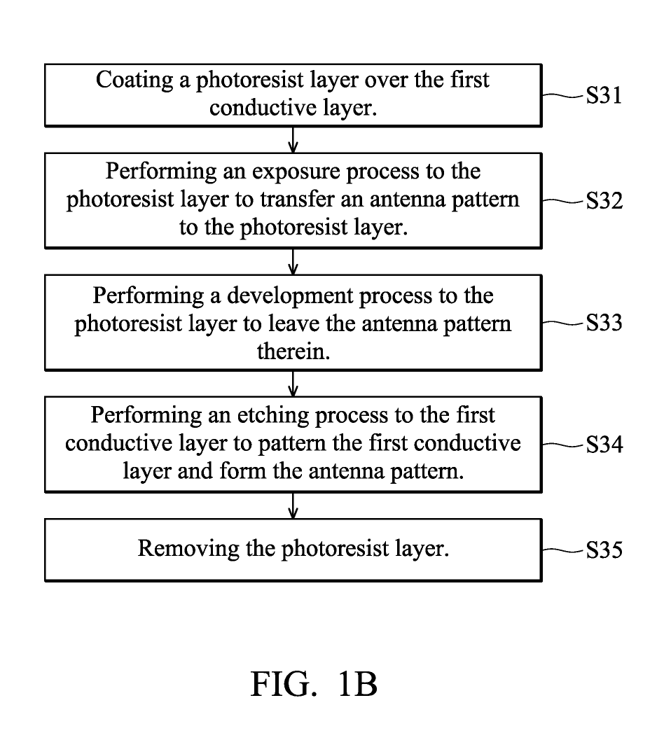

A first embodiment of an antenna producing process comprises the main steps shown in FIG. 1A. First, a substrate is provided, having a substrate surface (S1). Next, a first conductive layer is formed over the substrate surface (S2). Next, a patterning process is performed to the first conductive layer to form an antenna pattern in the first conductive layer (S3). Then, a thickening process is performed to form a second conductive layer over the first conductive layer, thereby increasing a thickness of the antenna pattern and forming a first exemplary antenna structure.

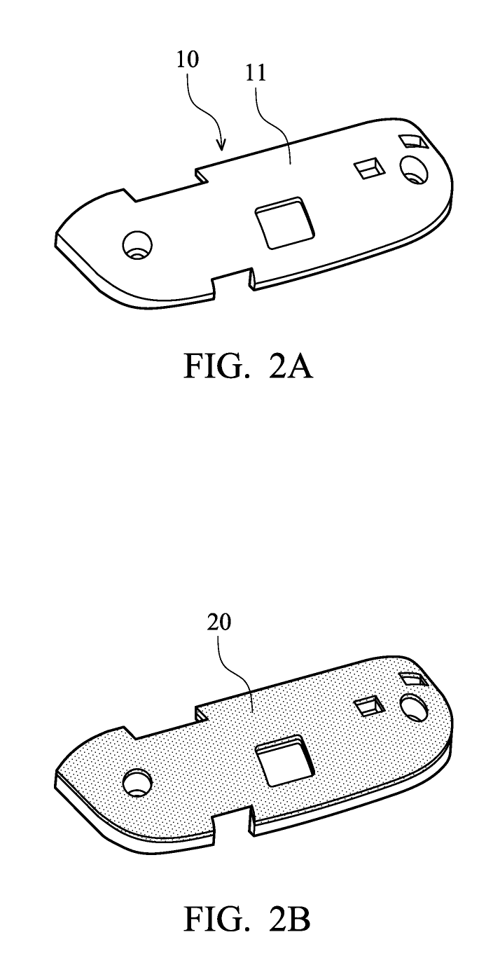

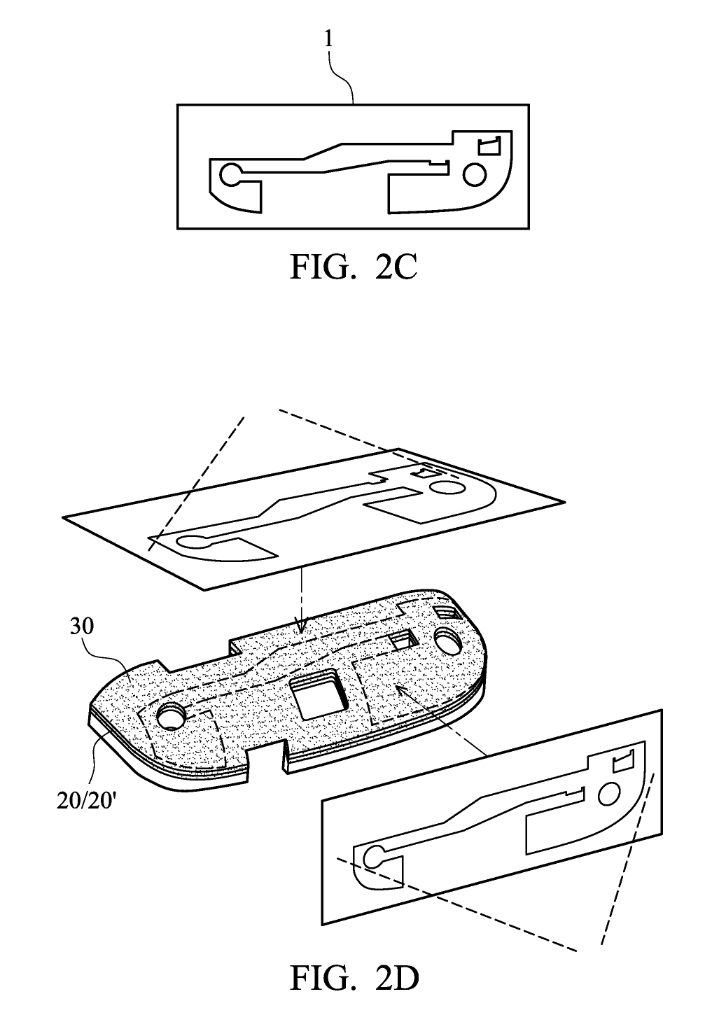

The substrate can be, for example, a case of a portable electronic device. The substrate surface can be an inner or outer surface of the portable electronic device. Referring to FIG. 2A, an exemplary substrate 10 is illustrated, having a substrate surface 11, and the substrate surface can be, for example, a curved surface.

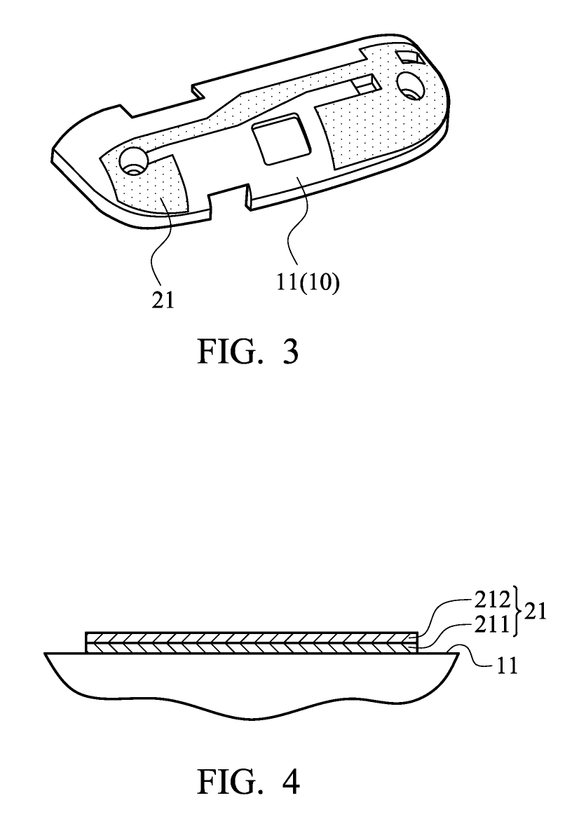

In FIG. 3, the first embodiment of the antenna producing process is applied to form an antenna 21 over the substrate surface 11 of the substrate 10, such that a space occupied by the antenna 21 can be reduced to a minimum, and an inner space of the portable electronic device can be saved, thereby reducing a volume of the portable electronic device.

Fabrication steps of the first embodiment of the antenna producing process are described as follows in greater detail.

Referring to FIG. 1A, prior to formation of the first conductive layer over the substrate surface (S2), the substrate surface can be roughened to thereby improve adhesion of the first conductive layer to the substrate surface.

For the step of forming the first conductive layer over the substrate (S2), a vacuum sputtering process can be performed to make metal ions adhere to the substrate surface. In FIG. 2B, a first conductive layer 20 adhered to the substrate surface 11 of the substrate 10 is illustrated.

In addition to the above mentioned vacuum sputtering process, other process such as a printing process can be used for forming the first conductive layer over the substrate surface.

Next, in FIG. 1B, for the step of performing the patterning process to the first conductive layer and forming the antenna pattern in the first conductive layer (S3), the following detailed steps are also performed:

First, a photoresist layer is coated over the first conductive layer (S31). Next, an exposure process is performed to the photoresist layer to transfer an antenna pattern to the photoresist layer (S32). Next, a development process is performed to the photoresist layer to leave the antenna pattern therein (S33). Next, an etching process is performed to the first conductive layer to pattern the first conductive layer and form the antenna pattern (S34). Next, the photoresist layer is removed (S35).

For the step of coating the photoresist layer over the first conductive layer (S31), the photoresist layer can be coated by methods such as spray coating or spin coating, thereby uniformly covering the first conductive layer with the photoresist layer.

In FIG. 2C, for the step of performing the exposure process to the photoresist layer to transfer the antenna pattern to the photoresist layer (S32), a photomask 1 with the antenna pattern is used. In FIG. 2D, since the substrate surface is a curved surface in one embodiment, a plurality of photomasks 1 can be used and aligned in various directions during the exposure process to transfer the antenna pattern to the photoresist layer 30. The directions for the exposure process may be perpendicular to each other.

After formation of the antenna pattern in the first conductive layer (S3), the thickening process is performed to increase a thickness of the antenna pattern (S4), wherein the thickening process can be, for example, chemical plating, electroplating or printing.

In FIG. 4, a cross sectional view of an antenna structure fabricated by the above exemplary method is illustrated. The antenna structure 21 comprises a first conductive layer 211 and a second conductive layer 212. The first conductive layer 211 is formed by a vacuum sputtering process. The second conductive layer 212 is formed over the first conductive layer 211, wherein the second conductive layer 212 is formed by methods such as chemical plating, electroplating or printing.

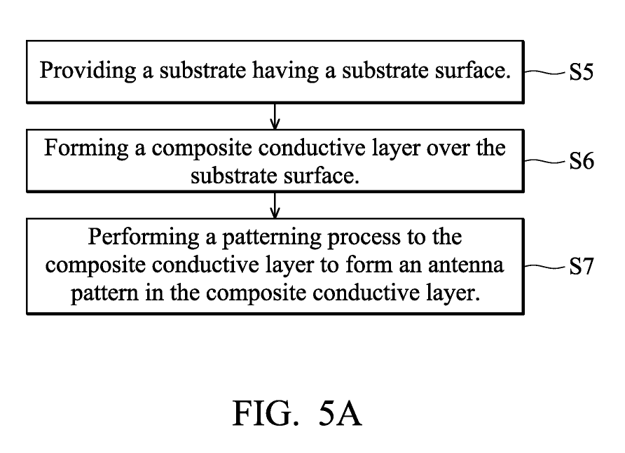

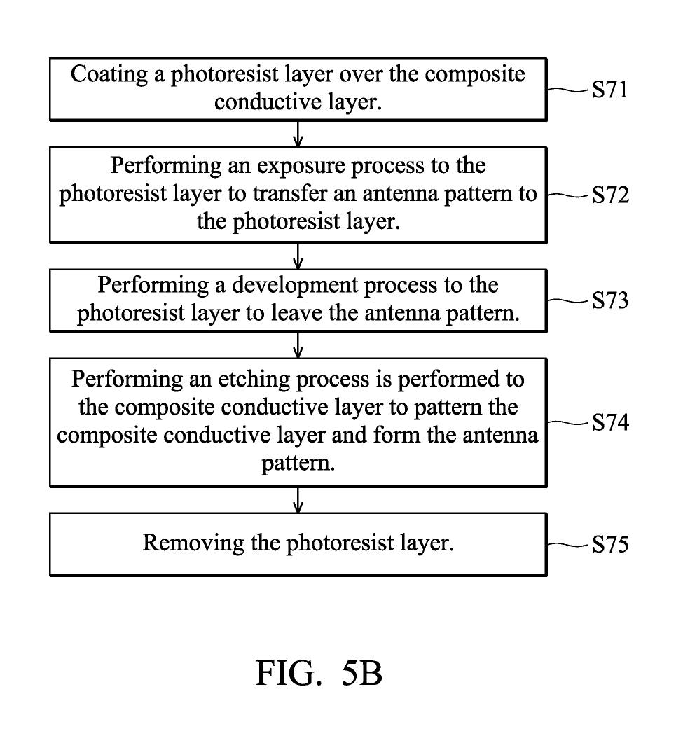

A second embodiment of an antenna producing process comprises the main steps shown in FIG. 5A. First, a substrate is provided, having a substrate surface (S5). Next, a composite conductive layer is formed over the substrate surface (S6). Next, a patterning process is performed to the composite conductive layer to form an antenna pattern in the composite conductive layer (S7) and form the second exemplary antenna structure.

The substrate can be, for example, a case of a portable electronic device. The substrate surface can be an inner or outer surface of the portable electronic device. Referring to FIG. 2A, an exemplary substrate 10 is illustrated, having a substrate surface 11, and the substrate surface can be, for example, a curved surface.

In FIG. 3, the second embodiment of the antenna producing process is applied to form an antenna 21 over the substrate surface 11 of the substrate 10, such that a space occupied by the antenna 21 can be reduced to a minimum, and an inner space of the portable electronic device can be saved, thereby reducing a volume of the portable electronic device.

Fabrication steps of the second embodiment of the antenna producing process are described as follows in greater detail.

Referring to FIG. 2A, prior to formation of the composite conductive layer over the substrate surface (S5), the substrate surface can be roughened to thereby improve adhesion of the first conductive layer to the substrate surface.

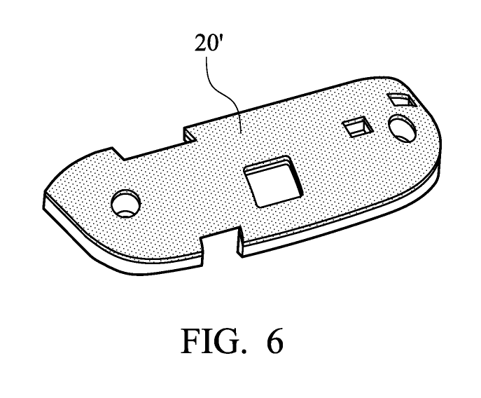

For the step of forming the composite conductive layer over the substrate (S6), a chemical plate process can be performed to form a first conductive layer (i.e. the first conductive layer 211 shown in FIG. 4) over the entire surface of the substrate. After formation of the first metal layer, another deposition process, for example an electroplating process, is then performed for a second conductive layer over the entire surface of the substrate (i.e. the second conductive layer shown in FIG. 4) and entirely covers the first metal layer. Herein, the second conductive layer and the underlying first conductive layer form a composite conductive layer formed over the substrate, wherein the second conductive layer is formed with a thickness greater than that of the first conductive layer, and the second conductive layer may comprise materials used for modern antenna fabrication and can be different from that of the first conductive layer. In FIG. 6, a composite conductive layer 20′ adhered to the substrate surface 11 of the substrate 10 is illustrated.

Next, in FIG. 5B, for the step of performing the patterning process to the composite conductive layer and forming the antenna pattern in the composite conductive layer (S7), the following detailed steps are also performed:

First, a photoresist layer is coated over the composite conductive layer (S71). Next, an exposure process is performed to the photoresist layer to transfer an antenna pattern to the photoresist layer (S72). Next, a development process is performed to the photoresist layer to leave the antenna pattern (S73). Next, an etching process is performed to the composite conductive layer to pattern the composite conductive layer and form the antenna pattern (S74). Next, the photoresist layer is removed (S75).

For the step of coating the photoresist layer over the composite conductive layer (S71), the photoresist layer can be coated by methods such as spray coating, spin coating or dipping, thereby uniformly covering the composite conductive layer with the photoresist layer.

In FIG. 2C, for the step of performing the exposure process to the photoresist layer to transfer the antenna pattern to the photoresist layer (S72), a photomask 1 with the antenna pattern is used. In FIG. 2D, since the substrate surface is a curved surface in one embodiment, a plurality of photomasks 1 can be used and aligned in various directions during the exposure process to transfer the antenna pattern to the photoresist layer 30. The directions for the exposure process may be perpendicular to each other.

In FIG. 4, a cross sectional view of an antenna structure fabricated by the above exemplary method is illustrated. The antenna structure 21 comprises a first conductive layer 211 and a second conductive layer 212. The first conductive layer 211 is formed by a chemical plating process. The second conductive layer 212 is formed over the first conductive layer 211, wherein the second conductive layer 212 is formed by electroplating. Herein the first conductive layer 211 and the second conductive layer 212 are first formed over the entire surface of the substrate and are then patterned by a patterning process, thereby forming the antenna structure 21.

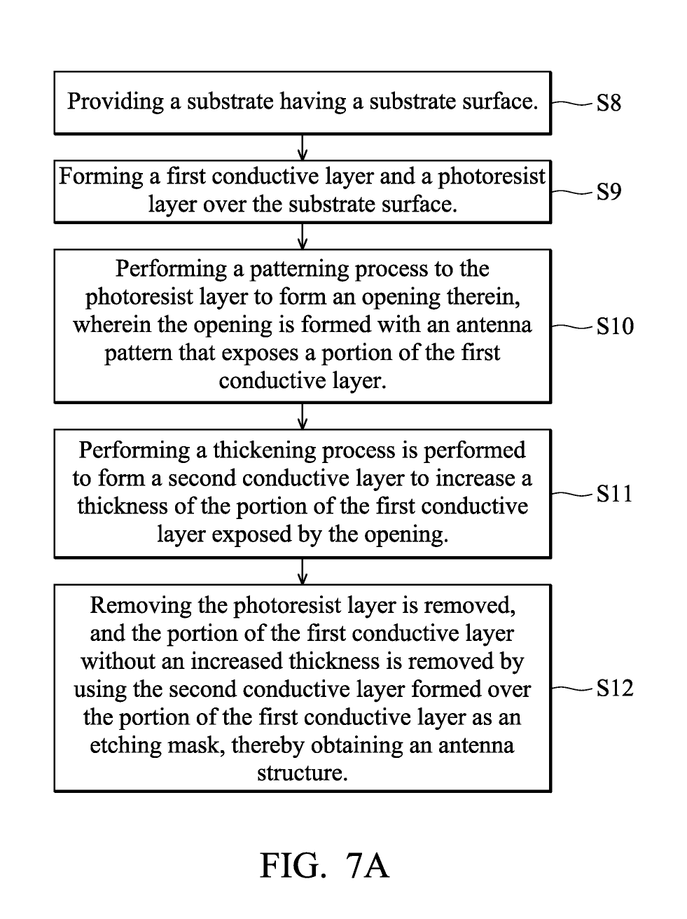

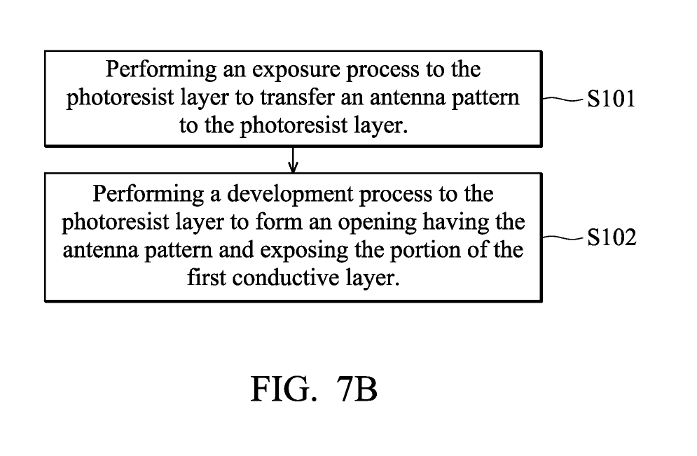

A third embodiment of an antenna producing process comprises the main steps shown in FIG. 7A. First, a substrate is provided, having a substrate surface (S8). Next, a first conductive layer and a photoresist layer are formed over the substrate surface (S9). Next, a patterning process is performed to the photoresist layer to form an opening therein, wherein the opening is formed with an antenna pattern that exposes a portion of the first conductive layer (S10). Next, a thickening process is performed to form a second conductive layer, thereby increasing a thickness of the portion of the first conductive layer exposed by the opening (S11). Next, the photoresist layer is removed, and the portion of the first conductive layer without an increased thickness is removed by using the second conductive layer formed over the portion of the first conductive layer as an etching mask, thereby obtaining an antenna structure (S12).

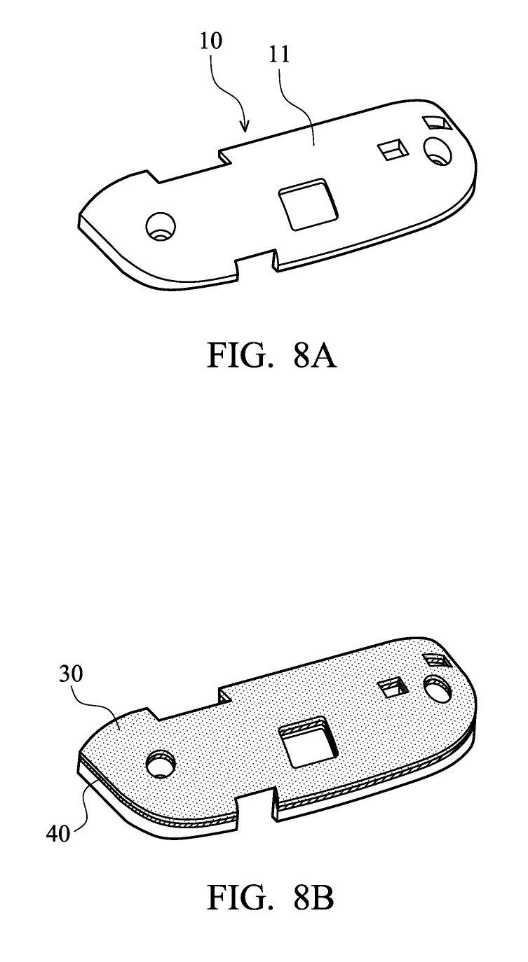

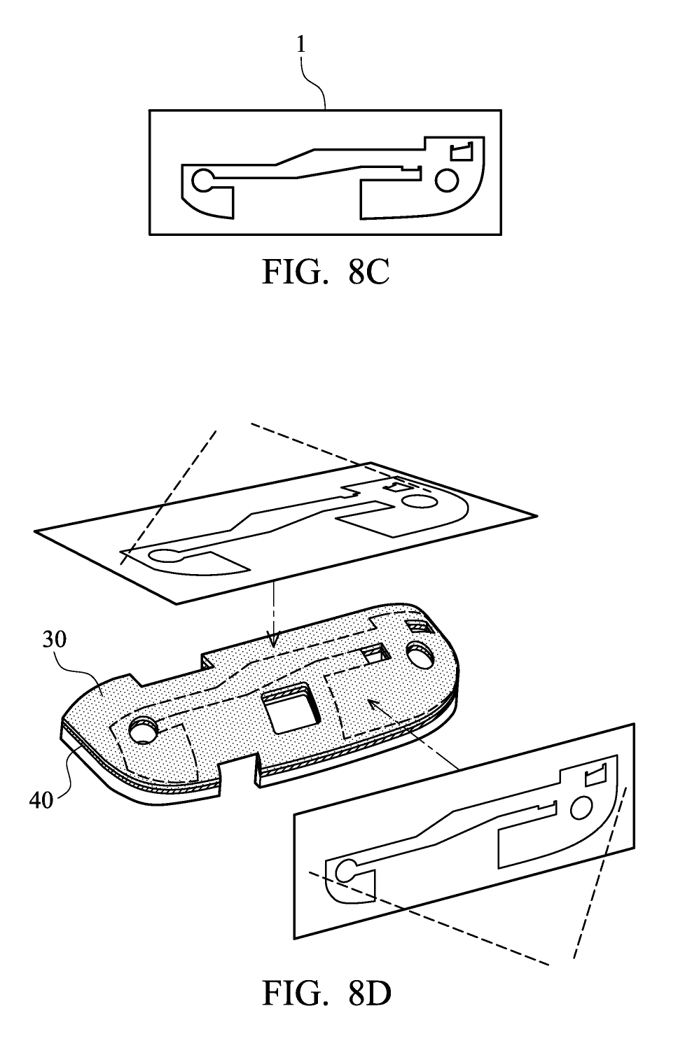

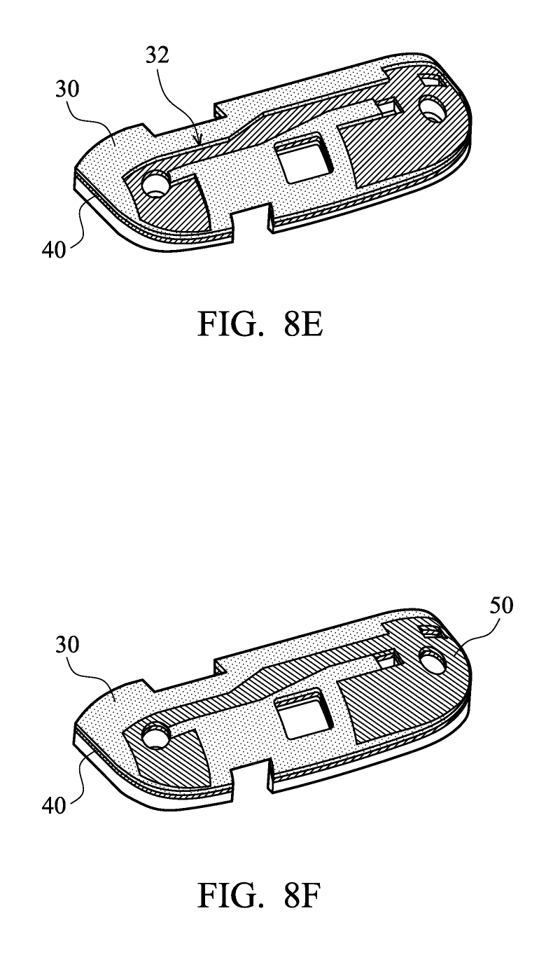

The substrate can be, for example, a case of a portable electronic device. The substrate surface can be an inner or outer surface of the portable electronic device. Referring to FIG. 8A, an exemplary substrate 10 of the invention is illustrated, having a substrate surface 11, and the substrate surface can be a curved surface.

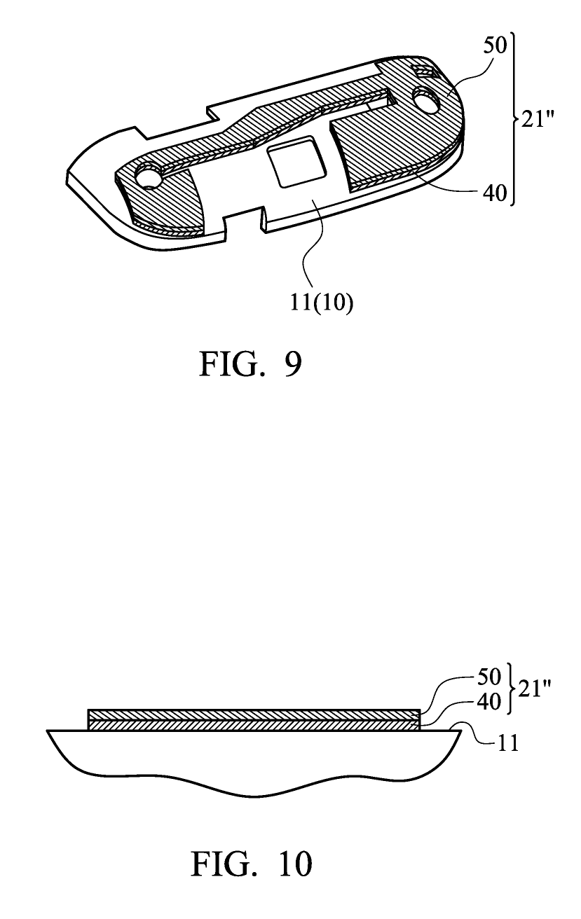

In FIG. 9, the third embodiment of the antenna producing process is applied to form an antenna 21″ over the substrate surface 11 of the substrate 10, such that a space occupied by the antenna 21″ can be reduced to a minimum, and an inner space of the portable electronic device can be saved, thereby reducing a volume of the portable electronic device.

Fabrication steps of the third embodiment of the antenna producing process are described as follows in greater detail.

Referring back to FIG. 8A, prior to formation of the first conductive layer and the photoresist layer over the substrate surface (S8), the substrate surface can be roughened to thereby improve adhesion of the first conductive layer to the substrate surface.

For the step of forming the first conductive layer and the photoresist layer over the substrate (S9), a process such as vacuum sputtering, chemical plating process, spray coating, or transfer printing can be performed to form a first conductive layer 40, and the first conductive layer 40 may comprise metal or conductive polymers. After formation of the first conductive layer 40, another deposition process such as spray coating, spin coating, or dipping is performed to uniformly cover the first conductive layer 40 with a photoresist layer 30 and thereby form the photoresist layer over the entire surface of the substrate. As shown in FIG. 8B, the first conductive layer 40 and the photoresist layer 30 sequentially formed over the substrate surface 11 of the substrate 10 are illustrated.

Next, in FIG. 7B, for the step of performing the patterning process to the photoresist layer to form an opening having an antenna pattern exposing a portion of the first conductive layer (S10), the following detailed steps are also performed:

First, an exposure process is performed to the photoresist layer to transfer an antenna pattern to the photoresist layer (S101). Next, a development process is performed to the photoresist layer to form an opening having the antenna pattern (S102), thereby exposing the portion of the first conductive layer.

Referring to FIG. 8C, for the step of performing the exposure process to the photoresist layer to transfer the antenna pattern to the photoresist layer (S101), a photomask 1 with the antenna pattern is used. In FIG. 8D, since the substrate surface is a curved surface in one embodiment, a plurality of photomasks 1 can be used and aligned in various directions during the exposure process to transfer the antenna pattern to the photoresist layer 30. The directions for the exposure process may be perpendicular to each other.

Referring to FIG. 8E, for the step of performing a patterning process to the photoresist layer to form the opening having the antenna pattern which exposes a portion of the first conductive layer, after the development process is performed to the photoresist layer, an opening 32 is left in the photoresist layer 30, and the opening 32 having the antenna pattern exposes a portion of the first conductive layer 40.

Referring to FIG. 8F, for the step of performing a thickening process to increase a thickness of the portion of the first conductive layer exposed by the opening (S11), a chemical plating or electroplating is performed to form the second conductive layer 50 to thicken a thickness of the portion of the first conductive layer exposed by the opening 32.

Next, the photoresist layer is removed, and an etching process (not shown) is performed, using the portion of the first conductive layer with increased thickness (e.g. the second conductive layer 50) as an etching mask, to the portion of the first conductive without a increased thickness (i.e. the first conductive layer 40 not covered by the conductive layer 50), thereby obtaining the antenna structure 21″ shown in FIG. 9 (S12).

In FIG. 10, a cross sectional view of an antenna structure fabricated by the above exemplary method is illustrated. The antenna structure 21″ comprises a patterned conductive layer 50 and a non-patterned conductive layer 40 formed thereover. The conductive layer 40 can be formed by, for example, electroplating, spray coating, or transfer printing, and the second conductive layer 50 is formed over the first conductive layer 40 by chemical plating or electroplating.

Compared to the antenna producing process described in the above first embodiment, the antenna producing process in the third embodiment moves the fabrication steps comprising the removal of the photoresist layer and the etching process to later steps of the process, such that when the thickening process is performed by, for example, electroplating, the non-patterned conductive layer 40 may function as a plating tool. Thus, there is no need to design a complex plating tool, and a plurality of antenna structures can be easily and simultaneously formed over the substrate.

In addition, compared with the antenna producing process described in the second embodiment, the thickening process in the third embodiment is only performed to a portion of the conductive layer, and there is no need to perform the thickening process to the entire conductive layer formed over the substrate, such that a cost for forming the conductive materials can be reduced.

Thus, the third embodiment of the antenna producing process may produce an antenna structure with lower cost and better yield than that described in the first and second embodiments. In addition, the photoresist layer used in the above processes can be replaced by a non-photoresist layer, and a laser engraving process may replace the exposure and development processes for performing the patterning process.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna producing process, comprising:
providing a substrate having a substrate surface;
forming a conductive layer on the substrate surface; and
performing a patterning process to the conductive layer, forming an antenna pattern of the conductive layer.

2. The process as claimed in claim 1, further comprising performing a thickening process to increase a thickness of the antenna pattern of the conductive layer.

3. The process as claimed in claim 1, wherein the conductive layer is a composite conductive layer, and the step of forming the composite conductive layer on the substrate surface comprises:
forming a first conductive layer on the entire surface of the substrate by chemical plating; and
performing an electroplating process to form a second conductive layer over the entire surface of the substrate, entirely covering the first conductive layer.

4. The process as claimed in claim 1, prior to forming the conductive layer over the substrate surface, further comprising roughening the substrate surface.

5. The process as claimed in claim 1, wherein the patterning process comprises:
coating a photoresist layer over the first conductive layer;
performing an exposure process to the photoresist layer, transferring the antenna pattern to the photoresist layer;
performing a development process to the photoresist layer, leaving the antenna pattern;
performing an etching process to the first conductive layer, forming the antenna pattern of the first conductive layer; and
removing the photoresist layer.

6. The process as claimed in claim 1, wherein the substrate has a curved surface.

7. The process as claimed in claim 5, wherein during the performing of the exposure process, a plurality of photomasks are used and are aligned in various directions to thereby transfer the antenna pattern to the photoresist layer.

8. The process as claimed in claim 1, wherein the substrate is a case of a portable electronic device.

9. An antenna structure, comprising:
a first conductive layer, wherein the first conductive layer is formed by vacuum sputtering; and
a second conductive layer formed over the first conductive layer, wherein the second conductive layer is formed by chemical plating, electroplating or printing.

10. A portable electronic device, comprising:
a case; and
an antenna structure formed over the case, wherein the antenna structure comprises a patterned composite conductive layer.

11. The device as claimed in claim 10, wherein the composite conductive layer comprises a first conductive layer and a second conductive layer formed over the first conductive layer, wherein the first conductive layer is formed by vacuum sputtering, and the second conductive layer is formed by chemical plating, electroplating, or printing.

12. The device as claimed in claim 10, wherein the composite conductive layer comprises a first conductive layer and a second conductive layer formed over the first conductive layer, wherein the first conductive layer is formed by chemical plating, and the second conductive layer is formed by electroplating.

13. The device as claimed in claim 10, wherein the composite conductive layer comprises a first conductive layer and a second conductive layer formed over the first conductive layer, wherein the first conductive layer is formed by vacuum sputtering, chemical plating, spray coating, or transfer printing, and the second conductive layer is formed by chemical plating or electroplating.

14. An antenna producing process, comprising:
providing a substrate having a substrate surface;
forming a first conductive layer and a photoresist layer over the substrate surface;
performing a patterning process to the photoresist layer, forming an opening in the photoresist layer, wherein the opening exposes a portion of the first conductive layer with an antenna pattern;
performing a thickening process to the first conductive layer, forming a second conductive layer to increase a thickness of the antenna pattern on the portion of the first conductive layer exposed by the opening; and
removing the photoresist layer, and etching portions of the first conductive layer without an increased thickness by using the second conductive layer formed on the portion of the first conductive layer as an etching mask.

15. The process as claimed in claim 14, prior to formation of the first conductive layer over the substrate surface, further comprising roughening the substrate surface.

16. The process as claimed in claim 14, wherein the patterning process comprises:
performing an exposure process to the photoresist layer, transferring the antenna pattern to the photoresist layer; and
performing a development process to the photoresist layer, forming the opening with the antenna pattern and exposes the portion of the first conductive layer.

17. The process as claimed in claim 14, wherein the substrate has a curved surface.

18. The process as claimed in claim 16, wherein during the performing of the exposure process to the photoresist layer, a plurality of photomasks are used and are aligned in various directions to thereby transfer the antenna pattern to the photoresist layer.

19. The process as claimed in claim 14, wherein the substrate is a case of a portable electronic device.
